(19) United States
(12) Patent Application Publication
(10) Pub. No.: US 2006/0284421 A1
(43) Pub. Date: Dec. 21, 2006

(54) High-pressure fuel line end fitting and method

(76) Inventors: Carl E. Fonville, Ann Arbor, MI (US); James M. Richards, Macomb, MI (US); James F. Reichenbach, Shelby Township, MI (US); Jeffrey J. Mantey, Washington, MI (US); James D. Hay, Milford, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/154,167

(22) Filed: Jun. 15, 2005

(51) Int. Cl. F16L 25/00; F16L 35/00

(52) U.S. Cl. 285/386; 285/332; 285/332.1

(57) ABSTRACT

The present invention relates to a connection assembly and method suitable for high-pressure applications. Specifically, end fittings securable to a fuel line may be configured to reduce the stress concentration factor between the fuel line and the end fitting. The end fitting is spherical and the mating structures have conical surfaces contacting the spherical end fitting to increase the assembly's tolerance of misalignments between the end fitting and mating fitting.

### TECHNICAL FIELD

The present invention relates to a high-pressure connection assembly for a fuel line with end fitting designed to allow for angular misalignment of a high pressure fuel line to a mating fitting in the connection so as to reduce the stress concentration factor between the end fitting and fuel line.

### BACKGROUND OF THE INVENTION

A high-pressure fuel line may be used to connect various components in a high-pressure fuel system (seeing pressures up to 180 bar), see FIG. 1. These fuel systems often utilize a metal-to-metal seal between mating components 16, 18 for robust sealing in various environmental conditions. Some end fittings 16 are designed with a flat backside 35 and a frontside 22 shaped as a half sphere, with offset radius center points A and B, to seal against the 60-degree conical surface 19 of a mating fitting 18. A tube nut 8 is then used to fasten the fuel line 9, which may be flexible, to the mating fitting with enough clamp force as to seal the metal-to-metal connection. The tube nut applies a force to the end fitting through a flat backside 35 of the end fitting 16 which is configured to interface with the mating fitting 18 at a 90 degree angle.

Misalignments between end fitting and mating fitting may be accommodated by a flexible fuel line which includes crimp joints between the tubing of the fuel line and its end fitting.

### SUMMARY OF THE INVENTION

What is desirable is a high-pressure connection assembly for a fuel line with end fitting and mating fitting configured to reduce the stress concentration factor between the end fitting and fuel line. The connection assembly includes a mating fitting and retention structure and uses two less joins, i.e., eliminating the flexible line crimp joints.

The end fitting has a spherical frontside and backside which complement the conical inner surfaces respectively of the mating fitting and retention structure.

In one embodiment of the invention, the conical mating surfaces of the retention structure and the mating fitting define a 60 degree conical surface.

Another aspect of this invention includes a fuel line assembly, having a fuel line configured to transport fluid at a high pressure and a connection assembly with an end fitting securable to the fuel line. The connection assembly defines a cavity into which the end fitting is fittable and which has facing bi-conical surfaces that cooperate with the end fitting to effect a seal.

Another aspect of the invention includes a method of reducing misalignment-induced stress concentration in a high pressure fuel line assembly which includes a fuel line, end fitting, mating fitting and retention structure. The method includes configuring an inner cavity between the mating fitting and the retention structure with angular walls, configuring the end fitting with a backside and frontside respectively co-operable with the mirrored angular walls of the mating fitting and retention structure and positioning the end fittings in the cavity between the mirrored angular walls so that at least one of the backside and frontside are in sealing contact with at least one of the mirrored angular walls.

More specifically, the present invention includes a high pressure connection assembly for a fuel line, having a mating fitting with a first connecting surface; an end fitting securable to the fuel line and matable with the mating fitting; and a retention structure for connecting the end fitting to the mating fitting and having a second connecting surface. The end fitting defines an orifice configured to permit fuel to flow from the fuel line to the matable fitting. Moreover, the end fitting defines a frontside and backside. The frontside is configured to sufficiently abut the mating fitting in a manner to effect a seal therebetween. The backside of the end fitting, in cooperation with the second connecting surface of the retention structure, is angularly or spherically configured with respect to the second connecting surface to complement the seal between the frontside of the end fitting and the mating fitting in a manner so as to reduce the stress concentration factor between the fuel line and the end fitting.

The full spherical end of the fuel line fitting eliminates the stresses in the fuel line caused by angular misalignment between the fuel line and the mating fitting. The spherical end allows easier assembly when angular misalignment exists between the spherical end of the fitting and its mating conical fitting. The lower stresses and easier assembly accommodates more misalignment between mating components and may avoid the need for flexible fuel lines.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side sectional view, partly in elevation, of an end fitting with a flat backside and a frontside configured substantially as a half sphere to interface with a mating fitting at a 90 degree angle;

FIG. 2 is a schematic side sectional view, partly in elevation, of a substantially full spherical end fitting with a backside substantially spherically configured in accordance with this invention to interface with the mating fitting in a manner so as to improve the stress concentration factor between the end fitting and a fuel line;

FIG. 3 is a fragmentary perspective view of the substantially spherical end fitting on a high pressure fuel line isolated from the mating fitting;

FIG. 4a is a schematic perspective view of a high pressure fuel line with a retention structure relatively rotatably connected and secured to the end fitting; and

FIG. 4b is a schematic perspective view of a high-pressure fuel line with the improved substantially spherical end fitting and without the retention structure shown in FIG. 4a.

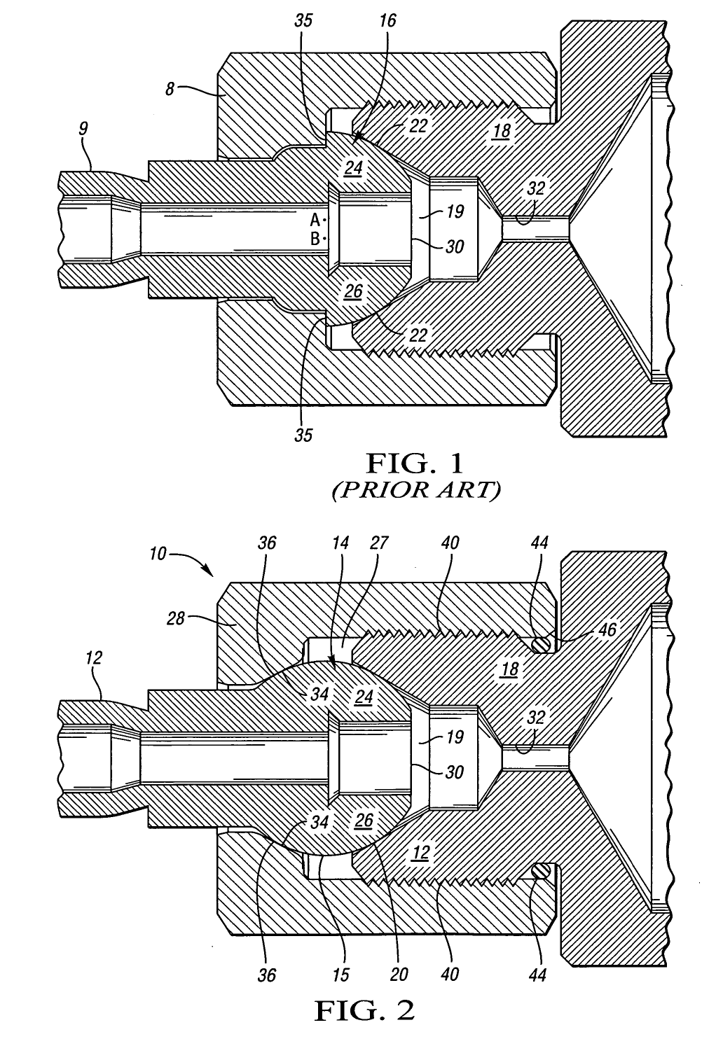

### DESCRIPTION OF THE PREFERRED EMBODIMENTS

Referring to the drawings, FIGS. 2 through 4b, wherein like characters represent the same or corresponding parts throughout the several views there is shown in FIG. 2 a schematic sectional side view of a high-pressure connection assembly 10 for a fuel line 12 with end fitting 14 having a substantially spherical outer surface 15. Fundamentally, the present invention includes a high pressure connection assembly 10 for a fuel line 12, having a mating fitting 18 with a first connecting surface 19; an end fitting 14 securable to the fuel line and matable with the mating fitting; and a retention structure or tube nut 28 for connecting the end fitting to the mating fitting and having a second connecting surface 34 (as shown in FIG. 2). The end fitting 14 defines an orifice 30 configured to permit fuel to flow from the fuel line 12 to the mating fitting 18. Moreover, the end fitting 14 defines a frontside 20 and backside 36. The frontside 20 is configured to sufficiently abut the mating fitting 18 in a manner to effect a robust seal therebetween. The backside 36 of the end fitting 14, in cooperation with the second connecting surface 34 of the retention structure 28, is angularly configured with respect to the second connecting surface 34 to complement the seal between the frontside 20 and the mating fitting 18 in a manner so as to reduce the stress concentration factor between the fuel line 12 and the end fitting 14. The term “angularly configured with respect to” refers to the two surfaces having a relative angle (i.e. not parallel), such as a spherical surface positioned against a conical surface, as described herein.

In high-pressure applications the end fitting must be securely sealed to the mating fitting 18 to prevent fuel from seeping out. Moreover, the end fitting and mating fitting 18 should be substantially sealed to maintain the desired pressure level within the fuel line 12. The upper and lower portions, 24 and 26 respectively, of the frontside 20 of the end fittings 14 and 16 define substantially semi-spherical surfaces, the two portions (24 and 26) have slightly offset radius center points (A for the upper portion and B for the lower portion, respectively). The retention structure or tube nut 28 is fastened to the fuel line 12 for relative rotation with respect to the end fitting 14 and the threaded mating fitting 18 to provide a clamp force sufficient to seal the mating fitting 18 to the end fitting 14. The end fitting 14 defines an orifice 30 to enable fuel to pass from the fuel line 12 to the mating fitting 18. The mating fitting 18 also defines an orifice 32 which directs the fuel in the desired direction at a predetermined pressure.

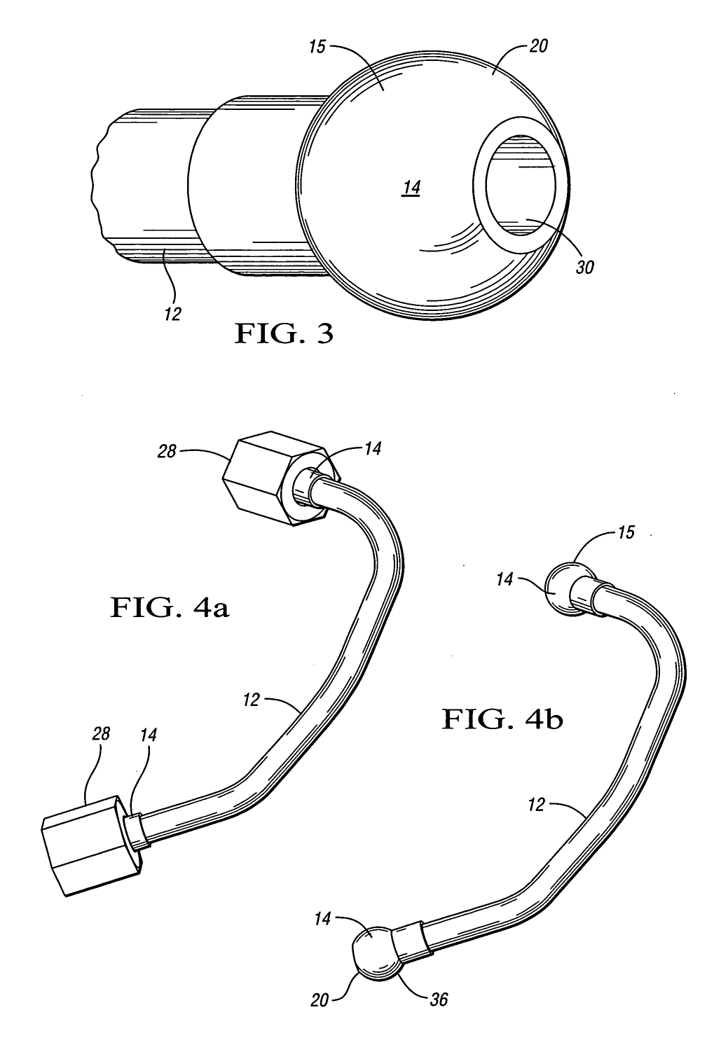

One technical advantage of the present invention is that the end fitting 14 is configured in a manner to compensate for angular misalignments between the fuel line and mating fitting and thereby reduce the stress concentration factor, if any, in the fuel line 12. Therefore, joint performance is not compromised by moderate misalignment between the mating fitting 18 and the end fitting 14 due to the full spherical outer surface 15 as shown in FIGS. 2 though 4b. In particular and with reference to FIGS. 2 and 3, the end fitting 14 has a substantially spherical frontside 20 and backside 36. This configuration enables the end fitting 14 and fuel line 12 to accommodate moderate misalignments between the fuel line and the mating fitting 18 whereby to reduce the stress concentration factor between the end fitting 14 and fuel line 12. The complementary spherical surface on the backside 36 of the end fitting 14, like the frontside, also has upper and lower portions (24 and 26 respectively) which are formed by radii having similar offset centers. However, the offset is minimized so that the outer surface of the end fitting 14 is more circular. The outer surface of the end fitting 14 is configured to be compatible with the inner conical surfaces 19 and 34 of the mating fitting 18 and the retention structure 28. Each of the fitting 18 and retention structure 28 approximately defines a 60 degree conical surface 19 and 34 respectively. Together they form a cavity 27 with facing bi-conical surfaces 19 and 34. Such mirrored angular walls cooperate with the spherical end fitting to effect a seal when the end fitting is sandwiched between the conical surfaces. The substantially spherical surfaces 20 and 36 of end fitting 14 are designed to complement these conical surfaces. The retention structure 28 is threaded at 40 to fasten to the mating fitting 18.

The retention structure 28, as shown in FIG. 4a, applies a force to the backside 36 of the spherical end fitting 14 through the conical inner surface 34. The retention structure 28 reinforces and secures the seal or connection between the end fitting 14 and the mating fitting 18 for the fuel line 12. An end fitting 14 and retention structure 28 are relatively rotatably fittable to each other at each end of fuel line 12 as shown in FIGS. 4a and 4b.

The assembly 10 may rely on a two-fold sealing system as shown in FIG. 2. Primary sealing is provided through the contact between the angled surface 36 of the end fitting 14 and conical surface 34 of the retention structure 28. If the primary seal is compromised—e.g., spherical surfaces 20 misaligning with conical surfaces 19—a secondary seal may be desirable. An optional flexible sealing member 44 may also be included in the assembly 10, as shown in FIG. 2, to prevent fuel from leaking outside of the assembly and to maintain the desired pressure level therein. The sealing member 44 (or as it may commonly be referred to the “o-ring”) is fittable between the mating fitting 18 and the retention structure 28. The sealing member 44 acts as a secondary seal, sealing the threaded portion 40 of the mating fitting 18 from the right side 46 of the retention structure 28.

Another benefit of the present invention is that the connection assembly 10 requires less parts than the prior art assembly 42. Specifically, the fuel line 12 has two fewer flexible line crimp joints between end fittings 14 and fuel line 12 than prior high pressure fuel connections. Moreover, the end fitting 14, mating fitting 18, and retention structure 28 are preferably made of stainless steel so as to reduce corrosion of the assembly parts under repetitious contact with various fuels.

A method of reducing misalignment-induced stress concentration in a high pressure fuel line assembly requires configuring an inner cavity 27 between the mating fitting 18 and the retention structure 28 with mirrored angular walls 19, 34 and configuring the end fitting 14 with a backside 36 and frontside 20 which cooperate with the mirrored angular walls 19, 34 of the mating fitting 18 and the retention structure 25. The positioning of the end fitting in the cavity 27 between the mirrored angular walls is such that at least one of the backside and frontside are in sealing contact with at least one of the mirrored angular walls.

The reduction of stress in the fuel line 12 resulting from the end fitting 14 enables the connection assembly 10 to be operable in 100% of all six sigma stack-up conditions. Though each production part (end fitting 14, fuel line 12, mating fitting 18 and retention structure 28) may vary within certain tolerances the end fitting 14 is configured to accommodate part variations so that the performance of the pressure line connection assembly 10 is not compromised.

While the best modes for carrying out the invention have been described in detail, those familiar with the art to which this invention relates will recognize various alternative designs and embodiments for practicing the invention within the scope of the appended claims.

1. A high pressure connection assembly for a fuel line, comprising:
a mating fitting having a first connecting surface;
an end fitting securable to the fuel line and matable with said mating fitting;
a retention structure for connecting said end fitting to said mating fitting and having a second connecting surface; wherein said end fitting defines an orifice configured to permit fuel to flow from said fuel line to said mating fitting; and
wherein said end fitting defines a frontside and backside, said frontside configured to sufficiently abut said mating fitting in a manner to effect a seal therebetween; and said backside of said end fitting in cooperation with the second connecting surface of said retention structure being angularly configured with respect to said second connecting surface to complement the seal between said frontside and said mating fitting so as to allow for angular misalignment of the fuel line to the mating fitting.

2. The assembly of claim 1, wherein said frontside and backside of said end fitting have a substantially spherical outer surface.

3. The assembly of claim 1, wherein said first and second connecting surfaces define conical mating surfaces respectively for said frontside and said backside of said end fitting.

4. The assembly of claim 3, wherein each of said mating surfaces define a 60 degree conical surface.

5. The assembly of claim 1, wherein said retention structure has a threaded portion for connecting said end fitting to said mating fitting.

6. The assembly of claim 1, further comprising:
a sealing member, fittable between said retention structure and said mating fitting, and configured to substantially prevent fuel from leaking there beyond.

7. A fuel line assembly, comprising:
a fuel line configured to transport fluid at a high pressure;
a connection assembly securable to said fuel line; wherein said connection assembly includes an end fitting securable to said fuel line; and
wherein said connection assembly defines a cavity into which said end fitting is fittable and wherein said cavity has facing bi-conical surfaces at least one of which is co-operable with said end fitting to effect a seal.

8. The assembly of claim 7, wherein said end fitting is spherical to cooperate with said at least one of said surfaces of said cavity of said connection assembly.

9. The assembly of claim 7, wherein said connection assembly includes a mating fitting securable to said end fitting by a retention structure.

10. The assembly of claim 9, wherein said retention structure has a threaded portion for connecting said end fitting to said mating fitting.

11. The assembly of claim 7, wherein each conical surface of the bi-conical surfaces of said cavity is conically configured at 60 degrees.

12. The assembly of claim 7, further comprising:
a sealing member, fittable with respect to said connection assembly, and configured to substantially prevent fuel from leaking beyond said connection assembly.

13. A method of reducing misalignment-induced stress concentration in a high-pressure fuel line assembly including a fuel line, end fitting, mating fitting and retention structure, comprising:
configuring an the inner cavity between the mating fitting and retention structure with mirrored angular walls;
configuring the end fitting with a backside and frontside respectively co-operable with the mirrored angular walls of said mating fitting and said retention structure; and
positioning said end fitting in said cavity between said mirrored angular walls so that at least one of said backside and frontside are in sealing contact with at least one of said mirrored angular walls.
